(19) United States
(12) Patent Application Publication
(10) Pub. No.: US 2012/0109650 A1
(43) Pub. Date: May 3, 2012

(54) APPARATUS AND METHOD FOR CREATING ACOUSTIC MODEL

(75) Inventors: Hoon-Young CHO, Daejeon (KR); Young-Ik Kim, Daejeon (KR); Il-Bin Lee, Daejeon (KR); Seung-Hi Kim, Daejeon (KR); Jun Park, Daejeon (KR); Dong-Hyun Kim, Seoul (KR); Sang-Hun Kim, Daejeon (KR)

(73) Assignee: Electronics and Telecommunications Research Institute, Daejeon (KR)

(21) Appl. No.: 13/284,095

(22) Filed: Oct. 28, 2011

(30) Foreign Application Priority Data
Oct. 29, 2010 (KR) 10-2010-0107205

(51) Int. Cl. G10L 15/14

(52) U.S. Cl. 704/238; 704/E15.028

(57) ABSTRACT

Disclosed herein is an apparatus and method for creating an acoustic model. The apparatus includes a binary tree creation unit, an information creation unit, and a binary tree reduction unit. The binary tree creation unit creates a binary tree by repeatedly merging a plurality of Gaussian components for each Hidden Markov Model (HMM) state of an acoustic model based on a distance measure reflecting a variation in likelihood score. The information creation unit creates information about information about the largest size of the acoustic model in accordance with a platform including a speech recognizer. The binary tree reduction unit reduces the binary tree in accordance with the information about the largest size of the acoustic model.

### CROSS REFERENCE TO RELATED APPLICATION

This application claims the benefit of Korean Patent Application No. 10-2010-0107205, filed on Oct. 29, 2010, which is hereby incorporated by reference in its entirety into this application.

### BACKGROUND OF THE INVENTION

1. Technical Field

The present invention relates generally to an apparatus and method for creating an acoustic model and, more particularly, to an apparatus and method for creating an acoustic model, which can directly approximate a variation in the likelihood score and automatically find a penalty value for the complexity of an acoustic model based on the Minimum Description Length (MDL) criterion, thereby being able to freely adjust the size of an acoustic model in accordance with the specifications of a platform without deteriorating performance.

2. Description of the Related Art

The recognition performance of Automatic Speech Recognition (ASR) has been continuously increasing thanks to the advent of high-speed processors, an increase in the capacity of memory, the development of parallel processing techniques, an increase in the number of speech language resources, etc. Meanwhile, speech recognition systems are being mounted on a variety of hardware platforms ranging from a server-class computer to a small-sized portable terminal or a household electronic appliance. Accordingly, when speech recognition systems are designed, it is necessary to adjust their sizes in accordance with the computational capacities of the platforms so that they can achieve maximum recognition performance.

In order to adjust the size of a speech recognition system, a method of changing the size of an acoustic model or a language model may be chiefly considered. That is, it is necessary to reduce the size of a model while preventing recognition performance from decreasing to a level equal to or lower than a predetermined level, or to increase the size of a model so that performance can be improved.

In a Hidden Markov Model (HMM)-based speech recognition method, adjusting the size of an acoustic model means increasing or decreasing the total number of all the mean vector and covariance matrix components (hereinafter referred to as “the total number of model parameters”) of all HMM states that constitute the acoustic model. The amount of computation of acoustic likelihood scores is equal to or exceeds one-half of the amount of overall computation of speech recognition, and therefore the adjustment of the size of an acoustic model is closely related not only to the size of a storage space for storing a model but also to speech recognition speed.

Research has been conducted into methods of learning an acoustic model using a sufficient number of model parameters with respect to given acoustic model learning data and gradually reducing the number of Gaussian mixture components for each HMM state in order to adjust the number of model parameter of an acoustic model in HMM-based speech recognition. These methods are configured to construct a binary tree by repeatedly merging two Gaussian components having the most similar probability distributions and prune the binary tree to an appropriate level, thereby creating an optimum acoustic model. In this case, for the purpose of measuring the distance between two Gaussian components, a Kullback-Leibler (KL) divergence measure, a Bhattacharyya distance measure, and the sum of the mixture weights of Gaussian components have been researched. Furthermore, a weighted KL divergence measure that reflects the weights of Gaussian components in the process of calculating the KL divergence between the Gaussian components has been proposed. It was reported that among these measures, the KL divergence measure achieved relatively desirable performance.

However, the conventional KL divergence measure is limited in achieving the minimization of the amount of variation in the likelihood store, which is the intrinsic purpose of similarity measurement and probability distribution integration. Furthermore, in the conventional method, the total number of Gaussian components of an acoustic model is determined based on a penalty value for the complexity of the acoustic model, which was predetermined in accordance with the Minimum Description Length (MDL) criterion. When information about the size of an acoustic model to be used in a system is provided, a variety of values should be tried one by one so as to find an appropriate penalty value.

### SUMMARY OF THE INVENTION

An object of the present invention is to provide an apparatus and method for creating an acoustic model, which can directly approximate a variation in the likelihood score and automatically find a penalty value for the complexity of an acoustic model based on the MDL criterion, thereby being able to freely adjust the size of an acoustic model in accordance with the specifications of a platform without deteriorating performance.

In order to accomplish the above object, the present invention provides an apparatus for creating an acoustic model, including a binary tree creation unit for creating a binary tree by repeatedly merging a plurality of Gaussian components for each HMM state of an acoustic model based on a distance measure reflecting a variation in likelihood score; an information creation unit for creating information about information about the largest size of the acoustic model in accordance with a platform including a speech recognizer; and a binary tree reduction unit for reducing the binary tree in accordance with the information about the largest size of the acoustic model.

The apparatus may further include a binary tree storage unit for storing the reduced binary tree.

In order to accomplish the above object, the present invention provides a method of creating an acoustic model, including measuring the distances between a plurality of Gaussian components for each HMM state of an acoustic model based on a distance measure reflecting a variation in likelihood score; creating a binary tree by repeatedly merging two Gaussian components having the shortest distance; and reducing the binary tree in accordance with information about the largest size of the acoustic model corresponding to a platform including a speech recognizer.

The method may further include storing the reduced binary tree.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a drawing schematically illustrating an apparatus for creating an acoustic model according to an embodiment of the present invention;

FIG. 2 illustrates a learned triphone HMM;

FIG. 3 is a diagram illustrating an algorithm for creating a binary tree using the binary tree creation unit of the apparatus for creating an acoustic model according to the embodiment of the present invention;

FIG. 4 is a diagram illustrating a process of reducing a binary tree using the binary tree reduction unit of the apparatus for creating an acoustic model according to the embodiment of the present invention;

FIG. 5 is a diagram illustrating a process of obtaining a penalty value adjustment variable for the complexity of a model using the binary tree reduction unit of the apparatus for creating an acoustic model according to the embodiment of the present invention; and

FIG. 6 is a flowchart illustrating a method of creating an acoustic model according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

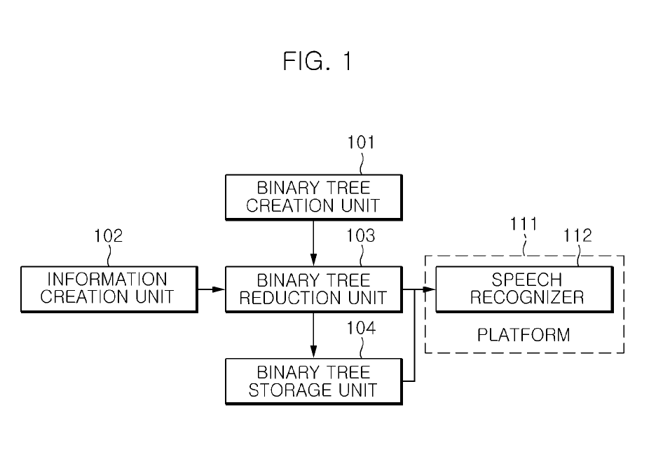

FIG. 1 is a drawing schematically illustrating an apparatus for creating an acoustic model according to an embodiment of the present invention.

The apparatus for creating an acoustic model according to an embodiment of the present invention may be configured to adjust the size of an acoustic model including a plurality of Gaussian components for each HMM state in accordance with a platform 111 and transfer it to a speech recognizer 112 included in the platform 111.

The platform 111 includes the speech recognizer 112, and may include a variety of platforms ranging from a small-sized terminal with limited computing resources, such as memory or a Central Processing Unit (CPU), to a server-class computer with almost not limited computing resources. The apparatus for creating an acoustic model according to an embodiment of the present invention may be configured to adjust the size of an acoustic model so as to recognize speech on such a variety of platforms.

As a prerequisite for the application of the apparatus for creating an acoustic model according to the embodiment of the present invention, the process of learning an acoustic model for speech recognition will now be described. The learning of an acoustic model for speech recognition requires a speech database in which speech pronounced by a plurality of utterers is stored, transcribed sentences which correspond to respective utterance files included in the speech database, and a pronunciation dictionary in which a pronunciation for each word is represented by means of phonetic symbols. An HMM-based statistical acoustic model is learned by a commonly known method using the above-described materials. The present invention is based on the assumption that L triphone HMM models having left-right acoustic context have been acquired.

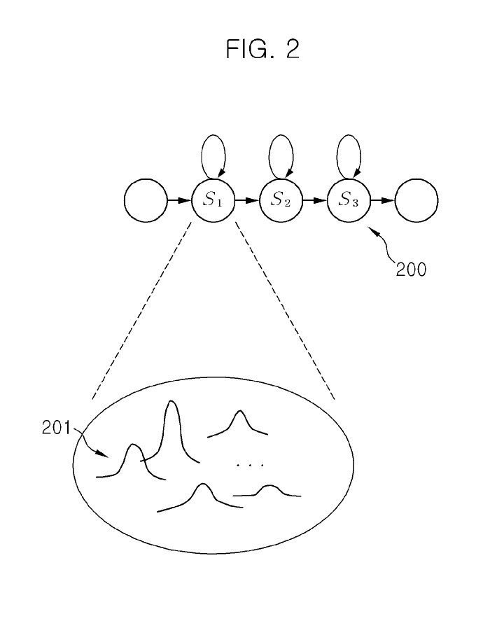

FIG. 2 illustrates a learned triphone HMM. s1, s2, and s3 200 indicate triphone HMM states, respectively. The arrows that connect the states indicate the probabilities of transitioning to the connected states, and the returning arrows indicate the probability of returning to their own states. Since the probability of transitioning from each state to another state and the probability of returning to its own state can be obtained using a known method, a detailed description thereof will be omitted here. In FIG. 2, it is assumed that each HMM state includes R Gaussian components 201. When a feature vector extracted from input speech is x, an output probability value in a specific HMM state s is calculated using the following equation:

$$Pr ( x \vert s ) = {\sum }_{r = 1}^{R} {G}_{r} ( x ) = {\sum }_{r = 1}^{R} {w}_{r} \cdot {g}_{r} ( x ) = {\sum }_{r = 1}^{R} {w}_{r} \cdot N ( x ; {μ}_{r} , {σ}_{r} ) \qquad ( 1 )$$

In Equation 1, wᵣ, μᵣ, and σᵣ are the mixture weight, mean vector and covariance matrix of an r-th Gaussian component, respectively. Furthermore, gᵣ(x) is the normal distribution of the r-th Gaussian component, and Gᵣ(x) is a normal distribution reflecting the weight of the r-th Gaussian component. In the speech recognition process, with respect to feature vectors extracted from each frame of input speech, the probability value of Equation 1 is calculated for the states of all the triphone HMMs included in the acoustic model. Accordingly, in order to increase speech recognition speed, it is important to reduce the number of all HMM states included in the acoustic model without deteriorating recognition performance.

Referring back to FIG. 1, according to an embodiment of the present invention apparatus for creating an acoustic model may include a binary tree creation unit 101, an information creation unit 102, a binary tree reduction unit 103, and a binary tree storage unit 104. The apparatus for creating an acoustic model shown in FIG. 1 is merely an example, and therefore some components thereof may be added, deleted or changed as necessary. For example, in another embodiment, an apparatus for creating an acoustic model may include only a binary tree creation unit 101, an information creation unit 102, and a binary tree reduction unit 103 without including a binary tree storage unit 104.

The binary tree creation unit 101 is a unit that creates a binary tree by repeating the process of merging a plurality of Gaussian components for each HMM state based on a distance measure reflecting a variation in the likelihood score. That is, the binary tree creation unit 101 measures the distances between the a plurality of Gaussian components for each HMM state based on the distance measure reflecting a variation in the likelihood score and then repeating the process of merging two Gaussian components having the shortest distance therebetween, thereby creating a binary tree. In this case, the binary tree creation unit 101 can obtain the distance measure reflecting a variation in the likelihood score by subtracting the approximate likelihood score after the merging of the plurality of Gaussian components from the approximate likelihood score before the merging. An algorithm for creating the binary tree using the binary tree creation unit 101 and the process of obtaining the distance measure reflecting a variation in the likelihood score will be described in detail below with reference to the drawings.

The information creation unit 102 is a unit that creates information about the largest size of the acoustic model that corresponds to the platform 111. The information about the largest size of the acoustic model may correspond to the specifications of the platform 111. That is, the acoustic model may have a size that varies depending on the specifications of a platform, such as internal memory, external memory and processing speed. Accordingly, the information creation unit 102 may receive platform-related information about the internal memory, external memory and processing speed of the platform 111, and create information about the largest size of the acoustic model corresponding to the platform 111 based on the received platform-related information.

The binary tree reduction unit 103 reduces the binary tree created by the binary tree creation unit 101 in accordance with the information about the largest size of the acoustic model created by the information creation unit 102. That is, the binary tree is reduced by receiving the information about the largest size of the acoustic model based on the limitations of the platform 111 such as internal memory, external memory and processing speed, pruning the binary tree created by the binary tree creation unit 101 and eliminating Gaussian components that does not greatly influence recognition performance. The binary tree reduction unit 103 may convert the information about the largest size of the acoustic model, created by the information creation unit 102, into the total number of Gaussian components to be included in the acoustic model, and then use it to reduce the binary tree. Furthermore, the binary tree reduction unit 103 may perform searching downwards from the root node of the binary tree, and then obtain an optimum subset of the nodes of the binary tree in accordance with the MDL criterion corresponding to the number of model parameters such as the weights, mean vectors and covariance matrices of Gaussian components. Furthermore, the binary tree reduction unit 103 may transfer the optimum subset of the nodes of the binary tree to the speech recognizer 112 so that the speech recognizer 112 of the platform 111 can perform speech recognition using the reduced acoustic model. The process of reducing a binary tree using the binary tree reduction unit 103 will be described in detail below with reference to the drawing.

The binary tree storage unit 104 may store the binary tree reduced by the binary tree reduction unit 103. The binary tree stored by the binary tree storage unit 104 may be used for speech recognition later. In addition to the binary tree, the binary tree storage unit 104 may store model parameters, such as the weights, mean vectors and covariance matrices of the Gaussian components, and the total number of Gaussian components to be included in the acoustic model.

As described above, using the above configuration, the apparatus for creating an acoustic model according to the embodiment of the present invention is configured to adjust the size of an acoustic model including a plurality of Gaussian components for each HMM state in accordance with the platform 111, and transfer it to the speech recognizer 112 included in the platform 111.

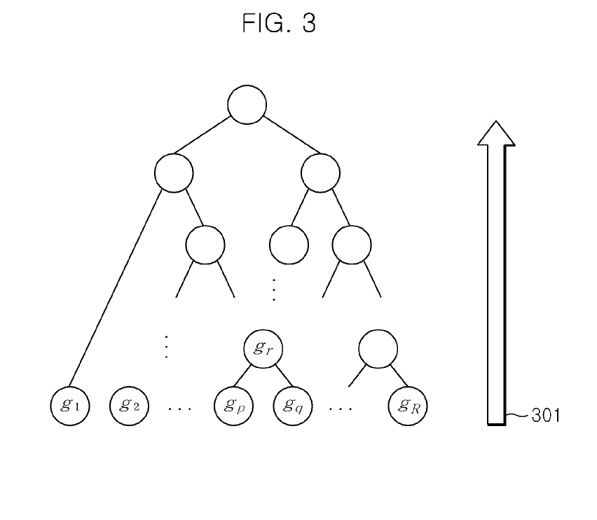

FIG. 3 is a diagram illustrating an algorithm for creating a binary tree using the binary tree creation unit of the apparatus for creating an acoustic model according to the embodiment of the present invention.

The algorithm for creating a binary tree using the binary tree creation unit 101 will now be described. First, the algorithm starts with forming R Gaussian components, included in a specific HMM state s, into respective leaf nodes. Thereafter, the distance between the Gaussian components of each pair of possible Gaussian components is measured, two Gaussian components having the shortest distance are found, and the two Gaussian components are merged into one. FIG. 3 shows the merging of gₚ with g_{q} into gᵣ. The merging is repeatedly performed on R−1 nodes g₁, g₂, g₃, . . . , gₚ₋₁, gᵣ, g_{q+1}, . . . , g_{R} until the last node remains. From FIG. 3, it can be seen that a tree creation direction 301 is an upward direction from the leaf node to the root node.

In the above algorithm, methods using a Kullback-Leibler (KL) divergence measure, a weighted KL divergence measure, a Bhattacharyya distance measure, or the sum of the mixture weights of Gaussian components as a distance measure, as described above, are presented as methods of measuring the distance between two Gaussian components. Such distance measures vary the topology of the binary tree shown in FIG. 3, and influence the performance of a finally created acoustic model.

The above enumerated existing distance measures prefer that the variation between the likelihood score before the merging of two Gaussian components and the likelihood score after the merging be small. However, these distance measures do not directly utilize the variation in the likelihood score.

The apparatus for creating an acoustic model according to the embodiment of the present invention utilizes a Delta-Likelihood (DL) distance measure, that is, a new distance measure that directly reflects the variation in the likelihood score. In FIG. 3, when a feature vector set used to estimate the parameter values of a Gaussian component gₚ is Xₚ={x₁, x₂, . . . , x_{N}} and γₚ(x) is the occupancy count of the feature vector x of the Gaussian component gₚ, the log likelihood score of the feature vector set Xₚ of the Gaussian component gₚ can be calculated using the following equation:

$$\begin{matrix}LL ( {X}_{p} \vert {g}_{p} ) = {\sum }_{i = 1}^{N} {γ}_{p} ( {x}_{i} ) log Pr ( {x}_{i} \vert {g}_{p} ) \\ = - 0.5 {γ}_{p} \cdot ( D log 2 π + log {σ}_{p} + D )\end{matrix} \qquad ( 2 )$$

In Equation 2, D is the dimension of the feature vectors, σₚ is he covariance matrix of the Gaussian component, and γₚ is calculated as

$${γ}_{p} = {\sum }_{i = 1}^{N} {γ}_{p} ( {x}_{i} ) .$$

When two Gaussian components gₚ and g_{q} are merged into gᵣ, the difference between the log likelihood scores before and after the merging may be calculated by the following Equation 3:

$$\begin{matrix}Δ = LL ( {X}_{p} \vert {g}_{p} ) + LL ( {X}_{q} \vert {g}_{q} ) - LL ( {X}_{r} \vert {g}_{r} ) \\ = - 0.5 ( {γ}_{p} \cdot log \vert {σ}_{p} \vert + {γ}_{q} \cdot log \vert {σ}_{q} \vert - ( {γ}_{p} + {γ}_{q} ) log \vert {σ}_{r} \vert )\end{matrix} \qquad ( 3 )$$

When the value of Equation 3 is small, the distance between the two Gaussian components gₚ and g_{q} can be determined to be short, and therefore the two components can be merged with each other. In Equation 3, in practice, learning data cannot always be provided in the speech recognition system, and therefore it is difficult to obtain the values of γₚ and γ_{q}. Accordingly, the present invention proposes a new distance measure that utilizes wₚ and w_{q} corresponding to the mixture weights of the Gaussian components instead of the above values. The proposed distance measure DL is defined as the following Equation 4:

d_{DL}(Gₚ(x),G_{q}(x))=(wₚ+w_{q})log|σᵣ|−wₚ log|σₚ|−w_{q} log|σ_{q}| (4)

The number of model parameters before the merging is twice the number of model parameters after the merging. When specific data is represented using a larger number of parameters, a greater likelihood score is obtained, and therefore the proposed Equation 4 always has 0 or a positive value.

A bottom-up binary tree is constructed using the distance measure obtained as described above, as shown in FIG. 3. Here, the merging of two Gaussian component gₚ and g_{q} into gᵣ means that the D-dimensional mean vectors μₚ and μ_{q} of the two Gaussian components are merged into a new D-dimensional mean vector μᵣ and the weights and covariance matrices of the Gaussian components are merged in the same way. As a specific method for doing this, an existing known common method may be utilized.

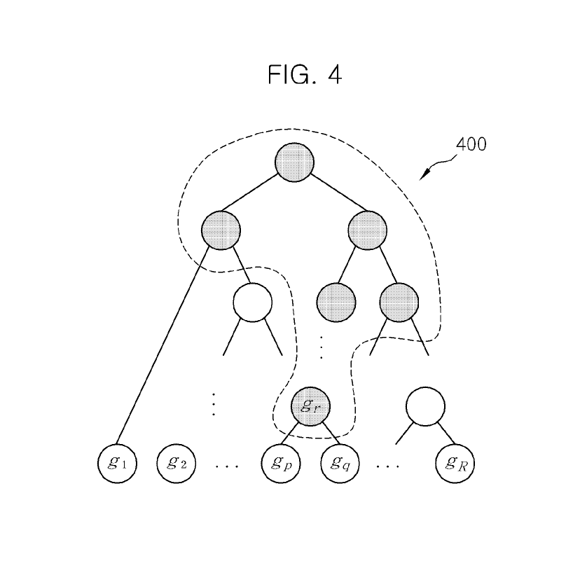

FIG. 4 is a diagram illustrating a process of reducing a binary tree using the binary tree reduction unit of the apparatus for creating an acoustic model according to the embodiment of the present invention.

As shown in FIG. 4, the process of reducing a binary tree is performed by sequentially evaluating all the nodes of the tree downwards from the root node of the tree. When the set of tree nodes through which the process has passed up to the intermediate point of the downward searching is Z and all model parameters included in Z are X={λ₁, λ₂, . . . , λₖ}, the description length of the model is calculated for the given feature vector set X={x₁, x₂, . . . , x_{N}}. The subset node of all possible subsets, which has a MDL, that is, an optimum subset 400, finally constitutes a reduced acoustic model. Here, the MDL criterion is defined as the following equation:

$$MDL ( X ) = {min}_{λ , k} \{ - log {P}_{λ} ( X ) + α \cdot \frac{k}{2} log N + C \} \qquad ( 5 )$$

Since in Equation 5, the probability increases in proportion to the modeling capability for given data, the value of the first term decreases as the number of model parameters increases. In the second term, k is the total number of model parameters. The value of the second term increases in proportion to the number of model parameters, and therefore it functions as a penalty for a gradual increase in the complexity of the model. The α value is a variable that adjusts the degree of penalty. A subset of finally selected all binary tree nodes varies depending on the above value. In the third term, C is a constant value, and is negligible because it does not influence the overall processing.

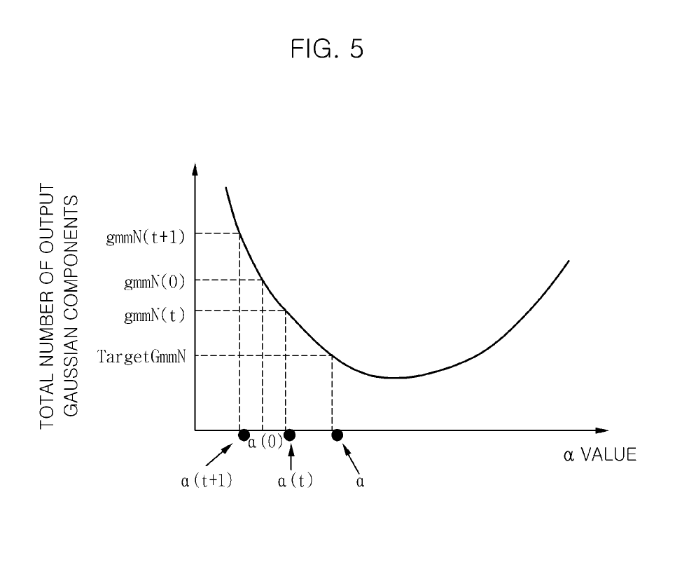

FIG. 5 is a diagram illustrating a process of obtaining a penalty value adjustment variable for the complexity of a model using the binary tree reduction unit of the apparatus for creating an acoustic model according to the embodiment of the present invention.

With regard to the penalty value adjustment variable α, in a conventional method, the total number of Gaussian components of the acoustic model is determined depending on the predetermined α value in Equation 5. In contrast, when information about the size of an acoustic model to be used in the system is provided, a variety of α values should be tried one by one so as to find an appropriate α value.

The apparatus for creating an acoustic model according to the embodiment of the present invention includes an algorithm for automating the process and automatically finding the optimum α value (see Equation 5) when the total number of finally desired Gaussian components is given. The graph of FIG. 5 shows the total numbers of Gaussian components of created acoustic models (denoted by gmmN in FIG. 5) along the y axis for different α values along the x axis. In FIG. 5, when the target total number of Gaussian components, that is, the TargetGmmN value, is given as information about the size of a target acoustic model (107 in FIG. 1), in order to find a corresponding value, the total number of Gaussian components of a created acoustic model, that is, gmmN(0) in FIG. 5, is obtained by applying Equation 5 to α(0), that is, an appropriate initial α value. If in a t-th iteration, the total number of output Gaussian components is gmmN(t−1) at α(t−1) and an acoustic model that satisfies the target total number of Gaussian components, that is, TargetGmmN, is created at α(t), the following equation is established.

$$\frac{TargetGmmN - gmmN ( t - 1 )}{α ( t ) - α ( t - 1 )} = Δ ( t ) \qquad ( 6 )$$

In Equation 6, assuming that the slope represented by Δ(t) changes slowly, Δ(t)≈Δ(t+1). Accordingly, when t+1 and Δ(t) are substituted for t and Δ(t+1), respectively, in Equation 6, the following Equation 7 is obtained.

$$α ( t + 1 ) = α ( t ) + \frac{1}{Δ ( t )} ( TargetGmmX - gmmN ( t ) ) \qquad ( 7 )$$

As the number of repetitions t is gradually increased from 0, gmmN(t) becomes closer to TargetGmmN. In this case, an optimum subset of nodes of the binary tree is obtained by applying α(t+1), and gmmN(t+1) at that time is calculated. Furthermore, when gmmN(t+1)=TargetGmmM, all Gaussian components may be output at that time, and the process of reducing the acoustic model may be terminated. When gmmN(t+1)≠TargetGmmM, t is increased by one, and the process restarts with the calculation of Equation 6.

Alternatively, the process of reducing the acoustic model may be terminated when the difference between gmmN(t+1) and TargetGmmM is equal to or smaller than a predetermined value, instead of when gmmN(t+1)=TargetGmmM. In this case, when the difference between gmmN(t+1) and TargetGmmM is not equal to or smaller than a predetermined value, t is increased by one, and the process restarts with the calculation of Equation 6.

Finally, when the size of an allowable acoustic model determined based on the hardware specifications of the platform on which the speech recognizer will be mounted is Q bytes and the total number of unique HMM states is N, the total number of unique Gaussian components usable in the overall acoustic model can be obtained using the following equation:

$$K = \frac{( \begin{matrix}Q - N \times size of memory for \\ storing number of mixtures for each state\end{matrix} )}{( MeanSize + CovSize + WeightSize )} \qquad ( 8 )$$

where MeanSize is the memory size of the mean vector, CovSize is the memory size of the covariance matrix, and WeightSize is the memory size of the Gaussian component weight value.

Widely known common methods are used as concrete HMM-based speech recognition methods, other than those that have been described in the above description.

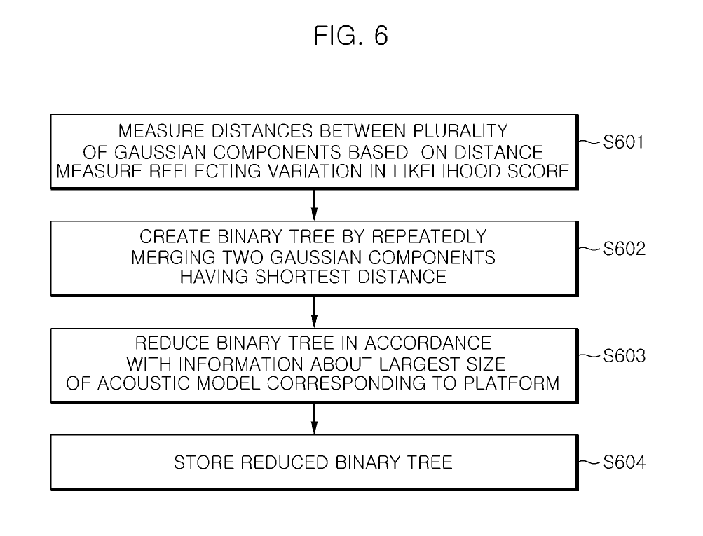

FIG. 6 is a flowchart illustrating a method of creating an acoustic model according to an embodiment of the present invention.

The method of creating an acoustic model according to the embodiment of the present invention may be configured to adjust the size of an acoustic model including a plurality of Gaussian components for each HMM state in accordance with a platform and transfer it to the speech recognizer included in the platform.

Referring to FIG. 6, when the method of creating an acoustic model according to the embodiment of the present invention starts, first the distances between the plurality of Gaussian components for each HHM state are measured based on a distance measure reflecting a variation in the likelihood score at step S601.

Thereafter, a binary tree is created by repeatedly merging two Gaussian components having the shortest distance at step S602. When the binary tree is created, IDs ranging from 1 to R are assigned to nodes corresponding to initial Gaussian components, and IDs sequentially increasing from R+1 by one are assigned to new nodes created after the merging, thereby creating the binary tree.

Once the binary tree is created at step S602, the binary tree is reduced in accordance with the information about the largest size of the acoustic model corresponding to the platform at step S603.

Once the binary tree has been reduced at step S603, the reduced binary tree may be stores at step S604.

Since the method of creating an acoustic model according to the embodiment of the present invention performs the process of creating an acoustic model similarly to the apparatus for creating an acoustic model according to the embodiment of the present invention shown in FIG. 1, the description given in conjunction with FIG. 1 is applied without change unless particularly described otherwise, and therefore a detailed description thereof will be omitted here. In FIG. 6, all the steps of the flowchart thereof are not essential, as in FIG. 1, and therefore some steps thereof may be added, deleted or changed in another embodiment. For example, in another embodiment, a method of creating an acoustic model may include all the steps (steps S601, S602, and S603) of the former embodiment, except for step S604.

As described above, the present invention provides the apparatus and method for creating an acoustic model, which can directly approximate a variation in the likelihood score and automatically find a penalty value for the complexity of an acoustic model based on the MDL criterion, thereby being able to freely adjust the size of an acoustic model in accordance with the specifications of a platform without deteriorating performance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for creating an acoustic model, comprising:
a binary tree creation unit for creating a binary tree by repeatedly merging a plurality of Gaussian components for each Hidden Markov Model (HMM) state of an acoustic model based on a distance measure reflecting a variation in likelihood score;
an information creation unit for creating information about information about a largest size of the acoustic model in accordance with a platform including a speech recognizer; and
a binary tree reduction unit for reducing the binary tree in accordance with the information about the largest size of the acoustic model.

2. The apparatus as set forth in claim 1, wherein the binary tree creation unit obtains the distance measure reflecting a variation in likelihood score by subtracting an approximate likelihood score after the merging of the plurality of Gaussian components from an approximate likelihood score before the merging.

3. The apparatus as set forth in claim 1, wherein the information creation unit creates the information about the largest size of the acoustic model corresponding to the platform based on platform-related information including information about internal memory, external memory and processing speed of the platform.

4. The apparatus as set forth in claim 1, wherein the binary tree reduction unit converts the information about the largest size of the acoustic model into a total number of Gaussian components to be included in the acoustic model.

5. The apparatus as set forth in claim 1, wherein the binary tree reduction unit searches the binary tree downwards from a root node of the binary tree, obtains an optimum subset of nodes of the binary tree in accordance with a Minimum Description Length (MDL) criterion, and then reduces the binary tree.

6. The apparatus as set forth in claim 5, wherein the binary tree reduction unit transfers the optimum subset of the nodes of the binary tree to the speech recognizer of the platform so that the speech recognizer can perform speech recognition using the reduced acoustic model.

7. The apparatus as set forth in claim 5, wherein the binary tree reduction unit obtains the MDL criterion by applying a penalty value adjustment variable for complexity of the acoustic model corresponding to a number of model parameters.

8. The apparatus as set forth in claim 7, wherein the binary tree reduction unit obtains the penalty value adjustment variable for complexity of the acoustic model based on the information about the largest size of the acoustic model.

9. The apparatus as set forth in claim 1, further comprising a binary tree storage unit for storing the reduced binary tree.

10. A method of creating an acoustic model, comprising:
measuring distances between a plurality of Gaussian components for each HMM state of an acoustic model based on a distance measure reflecting a variation in likelihood score;
creating a binary tree by repeatedly merging two Gaussian components having a shortest distance; and
reducing the binary tree in accordance with information about a largest size of the acoustic model corresponding to a platform including a speech recognizer.

11. The method as set forth in claim 10, wherein the creating a binary tree comprises obtaining the distance measure reflecting a variation in likelihood score by subtracting an approximate likelihood score after the merging of the plurality of Gaussian components from an approximate likelihood score before the merging.

12. The method as set forth in claim 10, wherein the creating a binary tree comprises:
assigning identifiers (IDs), ranging from 1 to R, to nodes corresponding to initial Gaussian components; and
assigning IDs, increasing from R+1 by one, to new nodes created after the merging.

13. The method as set forth in claim 10, wherein the reducing the binary tree comprises converting the information about the largest size of the acoustic model into a total number of Gaussian components to be included in the acoustic model.

14. The apparatus as set forth in claim 10, wherein the reducing a binary tree comprises:
searching the binary tree downwards from a root node of the binary tree: and
obtaining an optimum subset of nodes of the binary tree in accordance with an MDL criterion, and then reducing the binary tree.

15. The method as set forth in claim 14, further comprising, after the reducing the binary tree,
transferring the optimum subset of the nodes of the binary tree to the speech recognizer of the platform; and
the speech recognizer performing speech recognition using the reduced acoustic model.

16. The method as set forth in claim 14, wherein the reducing the binary tree comprises obtaining the MDL criterion by applying a penalty value adjustment variable for complexity of the acoustic model corresponding to a number of model parameters.

17. The method as set forth in claim 16, wherein the reducing the binary tree comprises obtaining the penalty value adjustment variable for complexity of the acoustic model based on the information about the largest size of the acoustic model.

18. The method as set forth in claim 10, further comprising storing the reduced binary tree.
